(19) United States
(12) Patent Application Publication
(10) Pub. No.: US 2006/0046719 A1
(43) Pub. Date: Mar. 2, 2006

(54) Method and apparatus for automatic connection of communication devices

(76) Inventor: David James Holtschneider, Durham, NC (US)

Correspondence Address: COATS & BENNETT/SONY ERICSSON, 1400 CRESCENT GREEN, SUITE 300, CARY, NC, 27511, US

(21) Appl. No.: 10/929,829

(22) Filed: Aug. 30, 2004

(51) Int. Cl. H04Q 7/20

(52) U.S. Cl. 455/434

(57) ABSTRACT

A method and apparatus for automatically initiating a long-range wireless connection between two or more communication devices is described herein. According to the present invention, an initiating communication device enters a connection request mode responsive to a connection request input. Once in the connection request mode, the initiating communication device searches for candidate communication devices operating in the connection request mode. Information is collected from the initiating and candidate communication devices. A long-range wireless connection is automatically initiated between the initiating communication device and one of the candidate communication devices based on the exchanged information. In one exemplary embodiment, a correlator compares discriminators associated with the connection request modes of the initiating and candidate communication devices to determine one or more correlation metrics. A long-range wireless connection is automatically initiated between a pair of communication devices having one or more correlation metrics that satisfy threshold criteria.

### BACKGROUND

The present invention relates generally to wireless communication devices, and more particularly to the automatic connection of two or more wireless communication devices.

Wireless networks have well-defined procedures and/or configuration requirements for establishing connections between specific communication devices, i.e., cellular telephones. In general, these procedures require input from an initiating communication device, where the input includes identification information associated with a target communication device, such as the target communication device's phone number, the target communication device's IP address, or the transceiver frequency configuration of the target communication device. As a result, the initiating communication device and/or the initiating user must have access to identification information associated with the target communication device.

However, in some situations, the initiating communication device and/or user does not have access to this identification information. For example, victims and rescue personnel at the scene of an emergency may be able to see each other and may each have wireless communication devices. However, if they are unable to establish a direct connection with each other, they may be unable to communicate effectively. As a result, the victims must go through additional channels, such as a 911 operator, to provide time-critical information to the rescue personnel, such as how many people are trapped in a particular area of a burning building.

Further, even if the user knows the identification information, in some situations it may be impractical or unsafe for the individual to provide the necessary input to the communication device to establish the wireless communication, such as when the individual's attention cannot be distracted by the demands of device display interpretation and keypad information entry. As such, conventional wireless connection procedures do not address all wireless connection needs.

### SUMMARY

The present invention comprises a method and apparatus that automatically initiates a connection between two or more communication devices. One exemplary communication device according to one embodiment of the present invention comprises an input device, a short-range transceiver, and connection circuitry. A user activates the input device to place the communication device in a connection request mode. When the short-range transceiver detects the presence of candidate communication devices operating in the connection request mode, the short-range transceiver exchanges information between the first communication device and the candidate communication devices. The connection circuitry automatically initiates a connection between the first communication device and a targeted candidate communication device based on the exchanged information.

According to one exemplary embodiment, the first communication device may also include detection circuitry and a correlator. The detection circuitry detects one or more discriminators associated with the connection request mode of the first communication device. The correlator generates a correlation metric by correlating the discriminators associated with the first communication device with discriminators obtained from the candidate communication devices. If the correlation metric meets or exceeds a threshold, the connection circuitry automatically initiates the long-range wireless connection using identification information obtained via the short-range transceiver.

Another exemplary embodiment according to the present invention comprises an input device, a long-range transceiver, and connection circuitry. A user activates the input device to place the communication device in a connection request mode. When the long-range transceiver detects one or more candidates operating in the connection request mode, the connection circuitry automatically initiates a long-range wireless connection between the first and one of the candidates using identification information obtained via the long-range wireless transceiver.

A wireless network according to the present invention may include a long-range wireless interface and a connection server. The long-range wireless interface detects a first communication device and one or more candidate communication devices operating in a connection request mode, and receives information from the first communication device and candidate communication devices. Based on the received information, the connection server automatically initiates a long-range wireless connection between the first communication device and one of the candidate communication devices.

### BRIEF DESCRIPTION OF THE DRAWINGS

FIG. 1 illustrates a block diagram of one exemplary communication device according to the present invention.

FIG. 2 illustrates a front view of one exemplary communication device.

FIG. 3 illustrates a back view of one exemplary communication device.

FIG. 4 illustrates one exemplary embodiment of a wireless network.

FIG. 5 illustrates a block diagram of one exemplary embodiment of a discriminator detector.

FIG. 6 illustrates a flow chart of one exemplary method for implementing the present invention.

### DETAILED DESCRIPTION

The present invention describes a method and apparatus for automatically initiating a long-range wireless connection between two or more wireless communication devices without advance knowledge of the identification information or configuration information associated with the target communication device. As used herein, the term “communication device” may include a cellular radiotelephone with or without a multi-line display; a Personal Communication System (PCS) terminal that may combine a cellular radiotelephone with data processing, facsimile, and data communication capabilities; a Personal Digital Assistant (PDA) that can include a radiotelephone, pager, Internet/intranet access, web browser, organizer, calendar, and/or a global positioning system (GPS) receiver; and a conventional laptop and/or palmtop receiver or other appliance capable of long-range wireless communication. Further, as used herein, “identification information” includes any information that may be used to identify the communication device(s), such as a phone number, an IP address, a transceiver frequency configuration, a mobile identification number, a PL tone, a privacy code, etc.

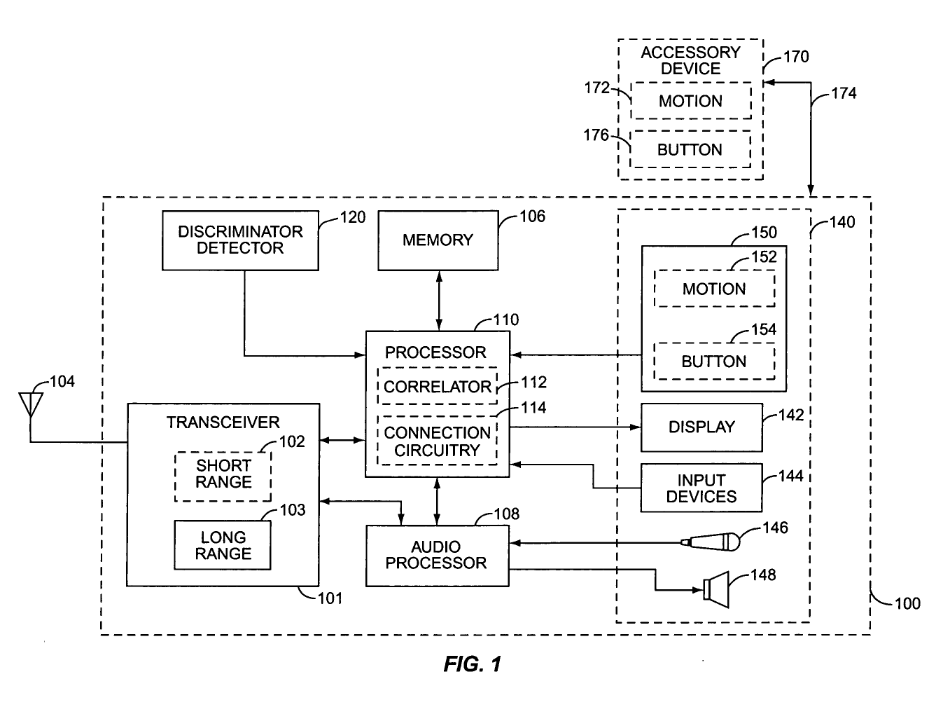

FIGS. 1-3 illustrate one exemplary communication device 100 according to one or more embodiments of the present invention. Communication device 100 includes a transceiver 101, antenna 104, memory 106, audio processor 108, system processor 110, detector circuit 120, and user interface 140. In addition, as discussed further below, communication device 100 may be associated with one or more accessory devices 170.

System processor 110 performs various processing tasks, including controlling the overall operation of communication device 100 according to programs stored in memory 106. The system processor 110 may be implemented in hardware, firmware, software, or a combination thereof, and may comprise a single microprocessor or multiple microprocessors. The microprocessors may be general purpose microprocessors, digital signal processors, or other special purpose processors. Functions performed by system processor 110 include signal processing, image processing, and control of the overall operation of communication device 100. In accordance with the present invention, and as discussed in greater detail below, signal processor 110 may optionally include connection circuitry 114 and a selector circuit, such as a correlator 112.

Memory 106 may include both random access memory (RAM) and read-only memory (ROM). Computer program instructions and data required for operation of communication device 100 are stored in non-volatile memory, such as EPROM, EEPROM, and/or flash memory, which may be implemented as discrete devices, stacked devices, or integrated with system processor 110.

Transceiver 101 is coupled to antenna 104 for receiving and transmitting wireless signals. Transceiver 101 preferably includes baseband processing circuits to process signals transmitted and received by the transceiver 101. Alternatively, baseband processing circuits may be incorporated in the system processor 110.

Transceiver 101 includes a short-range transceiver 102 and a long-range wireless transceiver 103, such as a cellular transceiver. While FIG. 1 shows a single antenna 104 for transceiver 101, it will be appreciated by those skilled in the art that antenna 104 may comprise multiple antennas for different types of transceivers, such as the short-range transceiver 102 and the long-range transceiver 103. Long-range wireless transceiver 103 may be a fully functional cellular radio transceiver, which may operate according to any known standard, including the standards known generally as the Global System for Mobile Communications (GSM), TIA/EIA-136, cdmaOne, cdma2000, UMTS, and Wideband CDMA. Transceiver 103 may alternatively be a two-way radio transceiver or 802.11 wireless network transceiver.

Short-range transceiver 102 is a short-range wireless transceiver, i.e., a Bluetooth® transceiver, that enables wireless communication between two or more communication devices over short distances. As understood by those skilled in the art, Bluetooth® is a universal radio interface that enables two or more wireless devices to communicate wirelessly via short-range ad hoc networks. Jaap Haartsen in Ericsson Review No. 3, 1998, provides further details regarding Bluetooth® technology in “Bluetooth®—The universal radio interface for ad hoc, wireless connectivity.” While the present application may use the term “Bluetooth® transceiver” and “Bluetooth® network” to refer to wireless communication over relatively short distances, i.e., less than 30 feet, those skilled in the art will appreciate that the present invention is not limited to Bluetooth® systems and equipment, and that other short-range systems, e.g., infra-red systems, are equally applicable.

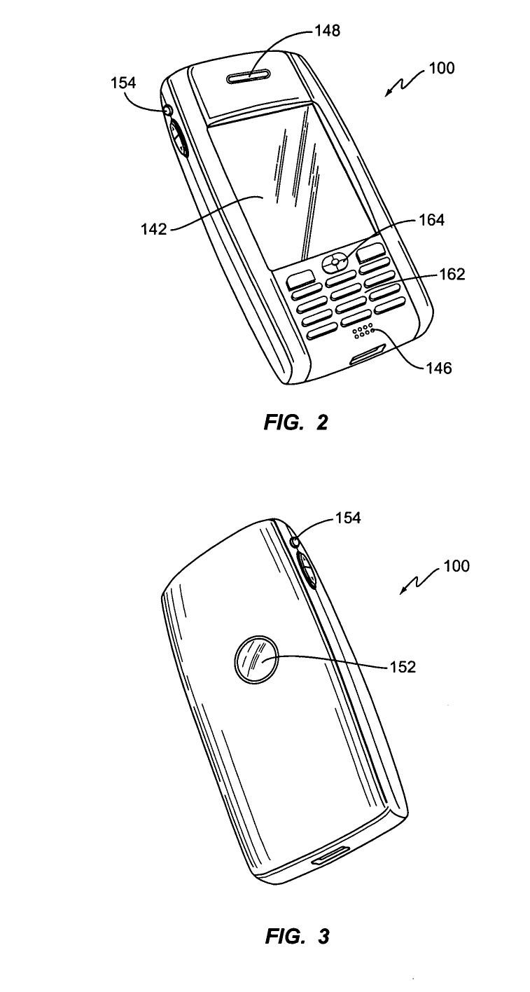

User interface 140 includes a display 142, one or more user input devices 144, a microphone 146, and a speaker 148. User interface 140 enables the user to interact with and control communication device 100. The user input devices 144 may include any of a keypad 162, touchpad, joystick control dials 164, control buttons 154, other input devices, or a combination thereof. A voice recognition system may also be included to receive user voice input. Exemplary user input devices 144, illustrated in FIG. 2, includes an alphanumeric keypad 162 and a joystick control 164 as is well known in the art. Keypad 162 and joystick control 164 allow the operator to dial numbers, enter commands, scroll through menus and menu items presented to the user on display 142, and make selections. Display 142 allows the operator to view information such as menus and menu items, dialed digits, images, call status information, and output from user applications.

Microphone 146 receives audio input from the user, while speaker 148 projects audible sound to the user. In particular, microphone 146 converts the detected speech and other audible signals into electrical audio signals and speaker 148 converts analog audio signals into audible signals that can be heard by the user. Audio processor 108 receives analog audio inputs from microphone 146 and provides the basic analog output signals to speaker 148.

In addition, user interface 140 includes a connection request mode input 150 that may place the communication device 100 in a connection request mode. When activated by the user, input 150 places the communication device 100 in the connection request mode. In one embodiment, connection request mode input 150 may comprise a control button, such as button 154 shown in FIGS. 2 and 3. By pressing control button 154, a user places the communication device 100 in the connection request mode.

In another embodiment, connection request mode input 150 may comprise a periodic signal/motion detector 152. Motion detector 152 may comprise any type of motion sensor known in the art, such as an accelerometer, an inertial switch, etc., for detecting motion associated with the communication device 100. In one exemplary embodiment, a camera associated with communication device 100 (see FIG. 3) may operate as the motion sensor 152. In these embodiments, the camera captures images according to means known in the art. By processing all or part of the captured images, an image processor and/or the system processor 110 may detect motion associated with the communication device 100. In any event, when motion sensor 152 detects a periodic motion or motion pattern such as waving motion associated with communication device 100, processor 110 places the communication device 100 in the connection request mode. It will be appreciated by those skilled in the art that other input devices 144, or other input sensors such as microphone 146, may be used to provide a connection request mode input as described above for periodic signal/motion detector 152.

Once in the connection request mode, the initiating communication device 100 searches for candidate communication devices 100 that are also operating in the connection request mode. Responsive to finding candidate communication devices 100 operating in the connection request mode, the initiating communication device 100 exchanges information with the candidate communication devices 100. Based on the exchanged information, either the initiating communication device 100 or one of the candidate communication devices 100 initiates the long-range wireless connection.

According to one embodiment of the present invention, when the initiating communication device 100 finds multiple candidate communication devices 100 in the connection request mode, the initiating communication device 100 may obtain various candidate discriminators associated with the candidate communication devices 100 to help determine which candidate communication device 100 is the target communication device 100. By comparing the candidate discriminators to corresponding discriminators associated with the connection request mode of the initiating communication device 100, the initiating communication device 100 may determine which candidate communication device 100 is the target communication device 100. For example, users mutually agreeing to make a connection may attempt to match their connection request discrimination information. They may each hold up and wave their communication device 100 to indicate that they wish to establish a connection. By making an effort to match the characteristics, such as the frequency, amplitude, phase relative to a real-time clock, and/or direction, of their mutual waving, the discrimination information captured by each communication device 100 yields a high correlation between the initiating and target communication devices 100. Once the correct initiating/target communication device pair is identified, exchanged identification information is used to initiate a long-range wireless connection between the identified pair of communication devices 100.

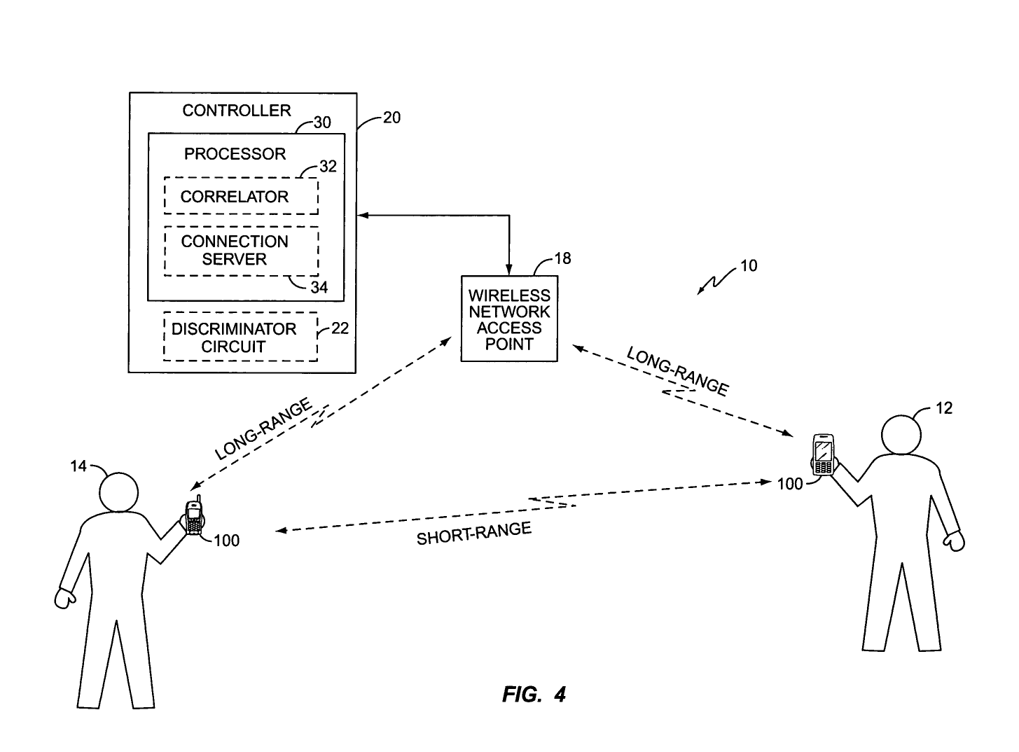

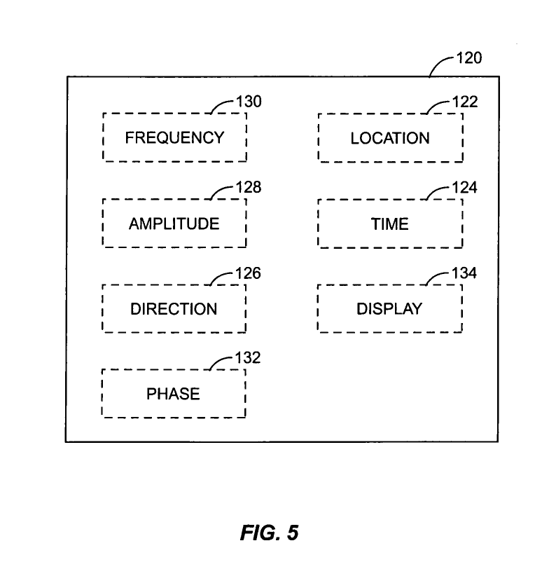

Referring now to FIGS. 4-5, the operation of the present invention will be described in more detail. FIG. 4 illustrates a wireless network, represented generally by reference number 10. Wireless network 10 includes an initiating user 12 and a target user 14, each having a communication device 100 capable of communicating via a short-range interface. While only two users 12, 14 and communication devices 100 are illustrated, those skilled in the art will appreciate that more users and communication devices 100 may be present in wireless network 10. Further, it will be appreciated that at any given time, the roles of the initiating and target users may be reversed, such that user 14 is the initiator and user 12 is the target. Wireless network 10 also includes one or more wireless network access points 18, such as a cellular base station, radio repeater, etc., and a controller 20, as discussed further below. It will be appreciated that each communication device 100 may communicate with different access points 18 and/or controllers 20. It will also be appreciated that while the wireless interface between the wireless access point 18 and the communication devices 100 is illustrated as a long-range wireless interface, this interface may comprise a short-range interface when, for example, the wireless interface comprises a two-way radio interface, such as an 802.11 interface.

According to the present invention, a communication device 100 enters a connection request mode when a user 12, 14 activates a connection request input 150 associated with communication device 100. In one exemplary embodiment, the user 12, 14 activates the connection request input 150 by activating a control button, such as button 154 on communication device 100. Alternatively, the user may activate the connection request input 150 by generating a motion pattern with the communication device 100. Such a motion pattern is detected by motion detector 152, and may be generated, for example, by waving communication device 100.

Once in the connection request mode, initiating communication device 100 may use the short-range interface to search for other candidate communication devices 100 operating in the connection request mode. Responsive to finding candidate communication devices 100 operating in the connection request mode, initiating communication device 100 exchanges information with the candidate communication devices 100. For example, the candidate communication devices 100 may provide discriminators to the initiating communication device 100 via the short-range interface. One exemplary discriminator comprises the frequency of the waving pattern used to place the candidate communication devices 100 in the connection request mode. For example, slowly waving the communication device 100 with an outstretched arm moving in a wide sweeping motion produces a waving pattern with a low frequency. Alternatively, using short motions to rapidly wave the communication device 100 back and forth produces a waving pattern with a higher frequency. In any event, by mimicking the frequency of the waving pattern generated by the initiating communication device 100, a target communication device 100 may distinguish itself from the other candidate communication devices 100, as discussed further below.

Once the frequency discrimination information is obtained, processor 110 in the initiating communication device 100 selects the target communication device 100 from the candidate communication devices 100 based on the provided frequency discrimination information. In one exemplary embodiment, a selector circuit such as a correlator 112 in processor 110 of initiating communication device 100 generates a correlation metric for each possible initiating/target communication device pair by, according to any known means, comparing the frequency discrimination information of the initiating waving pattern to the corresponding frequency discrimination information obtained from the candidate communication devices 100. The correlation metric that meets or exceeds a predetermined threshold corresponds to waving patterns that are sufficiently similar to be considered matching waving patterns. Thus, the initiating and target communication devices 100 associated with that correlation metric are identified as a matching pair of initiating/target communication devices 100. While the threshold of one exemplary embodiment is a fixed threshold, those skilled in the art will appreciate that the threshold may also be a variable threshold set by the wireless network and/or by the user. Further, it will be appreciated that any selector circuit that selects the target communication device 100 based on the frequency or other discriminator may be used in place of correlator 112.

Once a matching pair of initiating/target communication devices 100 are identified, the connection circuitry 114 in the initiating communication device 100 uses exchanged identification information, such as phone numbers, mobile identification numbers, IP addresses, operating frequency, PL tone, Privacy code, etc., to automatically initiate the long-range wireless connection. In the context of a cellular network example, the initiating communication device 100 places a call to the target communication device 100. However, from the perspective of the users 12, 14, both communication devices 100 provide some kind of alert to the users 12, 14 to indicate that the cellular connection has been initiated. For example, connection circuitry 114 may cause both devices to project an audible tone or ring to alert the users that a long-range wireless connection has been initiated. The first user to answer the alert may receive a ringback signal until the second user also answers the alert, at which point the long-range wireless connection between the two communication devices 100 is established. It will be appreciated that the target communication device 100 may alternatively initiate the long-range wireless connection using the exchanged identification information.

As discussed above, detection circuits 120 detect a frequency associated with the waving pattern of the corresponding communication device 100 in the connection request mode. However, detection circuit 120 may also detect other discriminators. FIG. 5 illustrates one exemplary embodiment of a detection circuit 120 according to the present invention. Detection circuit 120 may comprise a location detector 122, a real-time clock timer 124, a direction detector 126, an amplitude detector 128, a frequency detector 130, a phase detector 132, a display detector 134, and/or other detectors to detect various discriminators.

Direction detector 126, amplitude detector 128, frequency detector 130, and/or phase detector 132 detect various characteristics associated with the waving pattern generated by the corresponding communication device 100. Amplitude detector 128, frequency detector 130, and phase detector 132 detect an amplitude, frequency, and phase (relative to a real time clock 124), respectively, of the motion. Direction detector 126 detects the general direction of each motion of the communication device 100. For example, if holding communication device 100 in an upright manner, when communication device 100 is moved left to right, direction detector 126 will detect a generally horizontal motion. Alternatively, the direction detector 126 in a communication device 100 moving up and down detects a generally vertical motion. As will be appreciated by those skilled in the art, direction detector 126 together with the timestamp of each motion excursion peak may detect a complex pattern of motions. Further, direction detector 126 may detect more than one direction component of the motion pattern, such as one or more of three orthogonal components of motion in a three-dimensional space.

Location detector 122 comprises any device or system capable of determining a location of communication device 100, such as a GPS (Global Positioning System) device. Such location detectors are well known in the art, and therefore, are not discussed further herein. Real-time clock timer 124 detects a start time and/or stop time associated with the connection request mode events, such as when the communication device 100 enters/exits the connection request mode as well as the start and stop time of waving motions. Further, real-time clock timer 124 may provide timestamps for other discrimination information, such as direction and phase. Display detector 134 detects at least a portion of the contents of a display 142 of the communication device 100, i.e., characters input by the user 12, 14, a date, a time, an icon, etc.

While the detection circuitry 120 shown in FIG. 1 includes all of the above-described detectors, those skilled in the art will appreciate that detection circuitry 120 may only comprise a subset of the illustrated detectors. Further, those skilled in the art will appreciate that other types of detectors not discussed explicitly herein may also be included to detect other characteristics associated with the connection request mode of a communication device 100.

As discussed above, a correlator 112, in a communication device 100 correlates one or more discriminators, such as frequency, direction, amplitude, phase, etc., of initiating and candidate waving patterns to distinguish the target communication device 100 from the other candidate communication devices 100. However, if the resulting correlation metric is insufficient to determine the correct pairing, the initiating communication device 100 may request that the waving patterns be repeated and/or that the candidate communication devices 100 provide additional discriminators to further distinguish the target communication device 100 from the other candidate communication devices 100. For example, if a first correlation metric correlates only frequency information, initiating communication device 100 may request amplitude information from the candidate communication devices 100. Once the amplitude information is received, correlator 112 may generate a modified correlation metric that correlates frequency and amplitude information. By including the additional discriminators in the correlation process, correlator 112 may provide a more precise correlation metric for identifying the correct initiating/target communication device pairing.

In one embodiment, characters displayed on the displays of the initiating and target communication devices 100 may provide additional discriminators. For example, the initiating user 12 may press the number “1” on the keypad 162 while holding up a single finger so that the target user 14 can see it. The target user 14 then presses the number “1” on keypad 162. As a result, the displays of both the initiating and target communication devices 100 display the number 1. By detecting the contents of the initiating communication device's display 142 and comparing it to the display contents provided by the candidate communication devices 100, correlator 112 may further refine the correlation metric.

A location detector 122 in communication device 100 (or the known fixed location of the wireless network access point 18 serving each communication device) may also provide additional discrimination information by identifying the location of the candidate communication devices 100 and/or the initiating communication device 100, and provide the location information to the correlator 112 to further discriminate the target communication device 100 from other candidate communication devices 100 in the connection request mode. For example, the distances between the candidate communication devices 100 and the initiating communication device 100 may serve as a discriminating characteristic for correlator 112.

Additional discrimination characteristics may also be based on timing information. For example, timer 124 in the target communication device 100 may be used to mark the start time of the waving pattern associated with the target communication device 100. When the initiating user 12 notices that the target user 14 has begun waving, the initiating user 12 may provide an input to the initiating communication device 100 to estimate the start time of the target waving pattern. For example, the initiating user 12 may change the phase of the initiating communication device's waving pattern by rotating the initiating communication device 100, e.g., by 180°, to provide an estimate of the start time and/or the stop time of the target waving pattern to the initiating communication device 100. Alternatively, the initiating user 12 may press a key or button on the initiating communication device 100 to indicate the start time of the target waving pattern. In any event, the timer 124 of the initiating communication device 100 marks the start time of the target waving pattern based on the input providing by the initiating user 12. By comparing the actual start times of the candidate waving patterns provided by the candidate communication devices 100 to the estimated start time of the target waving pattern detected by the initiating communication device 100, an additional discriminator may be provided to correlator 112 to distinguish the target communication device 100 from the other candidate communication devices 100.

While the above examples illustrate various types of additional discrimination characteristics, it will be appreciated that the present invention is not limited to the described types. As such, other types of additional discrimination data not explicitly discussed herein may be used without deviating from the spirit of the present invention. Further, it will be appreciated that any of the above discriminators may be used alone or in combination to generate the desired correlation metric(s).

The above describes the invention in terms of using waving patterns to enter the connection request mode and to execute the automatic long-range wireless connection process. However, the present invention is not limited to the above-described waving patterns, and may instead be implemented with any type of periodic signal generated by the initiating communication device 100 and/or the target communication device 100 and detected by a periodic signal detector 152. According to the present invention, the periodic signals may be audio, visual, or a combination of both. For example, a visual periodic signal may comprise a waving pattern generated by the user 12, 14 of the communication device 100, as discussed above. Alternatively, a light source that periodically flashes light may form the basis for the visual periodic signal. The light flash embodiment may be particularly useful when attempting to use the present invention at night. One exemplary audio periodic signal may comprise a tone or other sound generated by the communication device 100 and processed by audio circuit 108, such as the tone generated by periodically pressing a key on keypad 162. Alternatively, the audio signal may comprise a sound generated externally from the communication device 100, such as a periodic click, snap, clap, etc., detected by microphone 146. Further, the periodic signal may comprise some combination of visual and audio signals, such as a periodic waving pattern combined with a periodic audio tone that matches some of the characteristics of the periodic waving pattern.

It will also be appreciated that a different communication device 100 may detect the audible/visual signal created by one communication device 100. For example, the initiating communication device 100 may be enabled to beep with each motion excursion peak. As the initiating user 12 waves their communication device 100, both the visual indication of the waving motion and the synchronous audible beeps are available to tell a target communication device 100 and/or target user 14 that a connection is being requested. The target user 14 may then attempt to mimic some of the observed initiating communication device's discriminating characteristic(s) to place the target communication device 100 in a connection request mode. Once in the connection request mode, detector 120 detects the discrimination information and provides the discrimination information to the initiating communication device 100. Alternatively, once placed in connection request mode, the initiating communication device 100 may capture discrimination information from the target communication device 100 by directly sensing discriminating characteristics associated with the target communication device 100. For example, the microphone 146 of the initiating communication device 100 may detect audible beeps produced by the target communication device 100. Alternatively, a camera associated with the initiating communication device 100 may be able to process video of the waving motion of the target communication device 100 to extract discrimination information.

It will also be appreciated that a target user 14 may generate a non-visual and/or non-audio periodic signal in response to the waving pattern of the initiating communication device 100. In one exemplary embodiment, the target user 14 may mimic the initiating waving pattern by generating a response periodic signal using the keypad 162. For example, target user 14 may repeatedly press “1” on the keypad 162 at a rapid pace to generate a periodic signal that mimics a small amplitude, high frequency waving pattern of the initiating communication device 100. Alternatively, the target user 14 may repeatedly press “9” at a slow pace to generate a periodic signal that mimics a large amplitude, low frequency waving pattern of the initiating communication device.

Note also that the characteristics of the periodic signal do not have to be constant and in fact may provide a higher degree of discrimination if varied over time during the connection request mode. The variation may be driven by the user of initiating communication device 100 or may be programmed as some form of prompt to guide, for example, the waving of the initiating user 12. By marking collected discrimination data with timestamps from the real-time clock timer 124, time varying characteristics of any discrimination data may be utilized to enhance the degree of discrimination.

While the above is described in terms of periodic signals generated by the users 12, 14 using their respective communication devices 100, various accessories 170 operatively connected to a communication device 100 with either a hardwire connection 174 or a short-range wireless connection 174 may alternatively be used to generate the periodic signal. For example, by waving a hand wearing a ring accessory 170 having a motion sensor 172 operatively connected to the communication device 100, a user may generate a waving pattern used to initiate a long-range wireless connection as described above. It will be appreciated that other accessories 170, such as a watch, headset, strap, etc., operatively connected to the communication device 100 may also be used to generate the periodic signal.

In addition, as briefly mentioned above, a user 12, 14 may enter the connection request mode without generating the periodic signal. For example, a user may place the communication device 100 in the connection request mode by activating a control button 154 on communication device 100 or a control button 176 on accessory 170. In this embodiment, the communication device 100 may detect discriminators, such as a location of the communication device 100, a start time of the connection request mode, display information, etc., to distinguish the communication device 100 from other communication devices 100. Further, the user may generate a periodic signal after the communication device 100 has entered the connection request mode using any of the above-described methods to provide additional discriminators.

The above describes a communication device 100 that uses a short-range transceiver 102 to locate other communication devices 100 in the connection request mode and to exchange information, i.e., discriminators and/or device identification information. However, there may be circumstances when the short-range transceiver 102 is insufficient. For example, in some instances, the distance separating initiating user 12 and target user 14 exceeds the distance limits of the short-range transceiver 102. Alternatively, obstacles between the initiating user 12 and the target user 14 may prevent the short-range transceivers 102 from exchanging information. When one or more communication devices 100 are operating in a short-range only operating mode, any of these circumstances may prevent the communication devices 100 from exchanging any data, and therefore may prevent the initiation of a long-range wireless connection. However, the long-range wireless transceiver 103 in communication device 100 may itself be used to collect and/or exchange the necessary information, i.e., discriminators and/or identification information between the pair of communication devices 100 via controller 20 as shown in FIG. 4.

As discussed above, wireless network 10 includes one or more wireless network access points 18 and at least one controller 20 having a processor 30. As understood by those skilled in the art, wireless network access point 18 communicates with communication devices 100 via a cellular or other long-range wireless interface, where controller 20 controls the operation of base stations 18 according to instructions executed by processor 30. In addition, controller 20 may include an optional discriminator circuit 22, and processor 30 may optionally include a correlator 32 and connection server 34.

Upon receiving the discriminators from one or more target communication devices 100 in the connection request mode, the controller 20 may provide the discriminators to the initiating communication device 100 to implement the above-described correlation process. Alternatively, the controller 20 may also collect the discriminators from communication devices 100 and execute the correlation process. For example, upon receiving the discriminators from two or more communication devices 100 in the connection request mode, correlator 32 may compare one or more of the received discriminators to generate the correlation metrics used to determine how to pair the communication devices 100. Controller 20 may request and receive the identification information from the initiating communication device 100 and/or the candidate communication device 100 corresponding to the correlation metric that meets or exceeds a threshold, and provide the long-range wireless identification information to the target and/or initiating communication device 100 to initiate the long-range wireless connection.

Alternatively, controller 20 may include a connection server 34 to automatically initiate the long-range wireless connection between the identified pair of communication devices 100. In this embodiment, for a cellular network example, connection server 34 receives the cellular identification information from both the initiating communication device 100 and the target communication device 100, places separate calls to each communication device 100, and transmits ringback to the first communication device 100 that answers. After the second communication device 100 answers, the connection server 34 stops sending ringback to the first communication device 100 and joins the two calls. From the perspective of the wireless network 10, this type of connection is simply a network-established conference call. In this embodiment, because network 10 remains attached as a silent participant in the conference call, network 10 is capable of handling special requests from either communication device 100 while the communication devices 100 are engaged in the conference call. For example, if one of the users 12, 14 realizes they are connected to the wrong communication device 100, the user may send a request to network 10 that asks for the current call to be released and for the network 10 to look for the next best correlation metric match. Alternatively, one of the communication devices 100 may use the present invention to try to join additional users to the current conference call. In one exemplary embodiment, DTMF (Dual Tone Multiple Frequency) tones may be used to communicate such requests.

In a wireless network example for this embodiment connection server 34 automatically initiates the long-range wireless connection between the identified pair of communication devices 100 using IP addresses provided by the wireless network access point 18. The wireless network access point 18 receives the IP address from both the initiating communication device 100 and the target communication device 100. As a result, a chat session may be established between the communication devices 100 with the connection server 34 included as a supervisor of the chat session. In a two-way radio example for this embodiment, configuration information associated with the target communication device 100 may be used to reconfigure the initiating communication device 100 and thereby to establish the long-range wireless connection. Alternatively both communication devices 100 may be reconfigured to a common configuration.

The above describes that controller 20 receives the discriminators from the communication devices 100. However, controller 20 may also detect the discriminators associated with one or more communication devices 100 in the connection request mode using discriminator circuit 22.

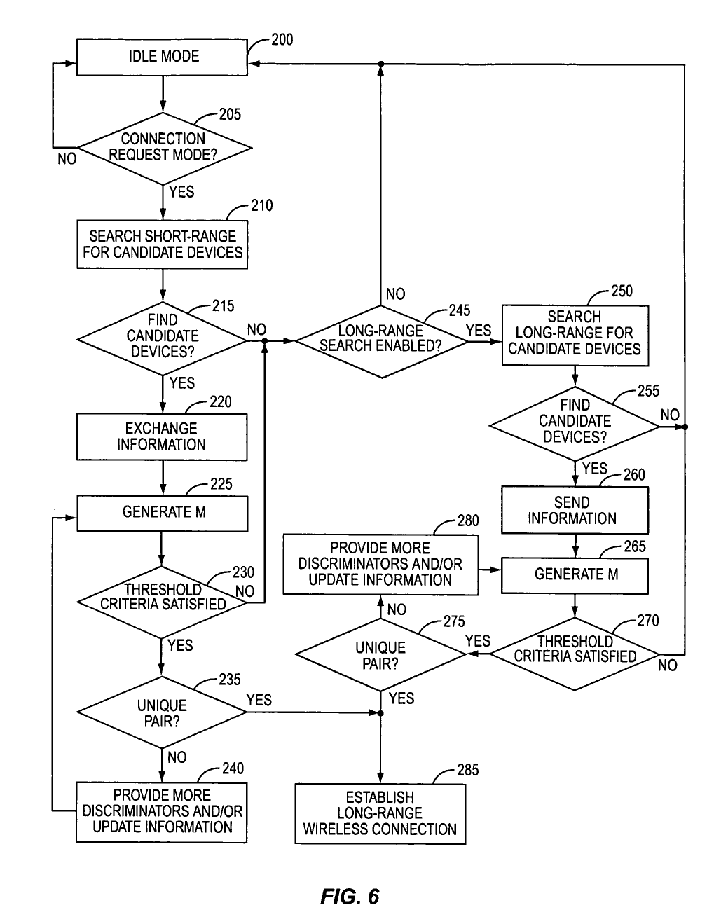

FIG. 6 shows a flow chart illustrating one exemplary process for implementing the present invention. As shown generally in FIG. 6, while a communication device 100 is in an idle mode (block 200), the communication device 100 waits for the communication device 100 to enter a connection request mode (block 205). As discussed above, communication device 100 may enter the connection request mode when the user 12, 14 presses a button or generates a motion pattern or other periodic signal with the communication device 100. Once communication device 100 enters the connection request mode, the short range transceiver 102 searches for candidate communication devices 100 operating in the connection request mode (block 210). If candidate communication devices 100 operating in the connection request mode are found (block 215), the initiating communication device 100 and the candidate communication devices 100 exchange discrimination and identification information (block 220). Correlator 112 in the initiating communication device 100 generates a correlation metric M between its discrimination information and the discrimination information received from each candidate communication device 100 (block 225). Processor 110 determines if any of the correlation metrics M meet or exceed a threshold criteria (block 230). Each dimension of correlation metric M may be independently weighted. This allows any dimension to be effectively disabled with a weighting of zero if desired. Further, multiple discrimination dimensions may be combined to simplify the threshold comparisons. In addition, several different acceptable thresholds T₁, T₂, T₃, etc., may be defined along with different weighting values W₁, W₂, W₃, etc. The threshold criteria may then be satisfied by, for example, any of the following types of threshold comparisons: (M×W₁≧T₁) or (M×W₂≧T₂) or (M×W₃≧T₃). The pair of communication devices 100 that meet or exceed predefined threshold criteria is identified as a matched pair of communication devices 100.

If multiple communication devices 100 satisfy some specified minimum of the threshold criteria (blocks 230, 235), additional discriminators may be provided and/or processor 110 may update the discrimination information to further evaluate the discrimination characteristics (block 240). For example, assume MA represents the correlation metric between candidate communication device A and the initiating communication device 100, and MB represents the correlation metric between candidate communication device B and the initiating communication device 100. If both candidate communication devices exceed the same threshold criteria, i.e., T₃, the best match may be determined by identifying the greater of M_{A}×W₃ and M_{B}×W₃. If the candidate communication devices each exceeded different threshold criteria say M_{A}×W₁≧T₁ and M_{A}×W₂≧T₂ and M_{B}×W₃≧T₃, processor 110 may calculate the percentage that each weighted correlation metric exceeds its respective threshold, and then sum and compare the results for each candidate communication device. For example, if (M_{A}×W₁) is 10% greater than T₁ and (M_{A}×W₂) is 20% greater than T₂ but (M_{B}×W₃) is 50% greater than T₃, then M_{A} is 10%+20% above the corresponding thresholds while M_{B} is 50% above the corresponding threshold. Therefore, candidate communication device B may be identified as the best match for initiating communication device 100. It will be appreciated that the correlation metric(s), the weighting value(s), and the threshold(s) may all be multidimensional with each dimension representing a different type of discrimination characteristics. This example is intended to illustrate one possible means to implement the invention, and therefore, is not intended to be limiting.

In any event, a long-range connection is automatically initiated between the matched pair of communication devices 100 (block 285) using the exchanged identification information as described above. In the case of a mobile telephone example, the identification information includes the phone number so that a voice call may be established over a cellular network. In the case of a PDA 100, the identification information includes the IP address so that a chat session may be established over a wireless network to internet connection. In the case of two-way mobile radio, the identification information includes the TX & RX frequency along with any PL tone so that the connection may be established by automatically programming one transceiver to match the other transceiver's configuration. Alternatively, both transceivers 101 may be reprogrammed to a new common configuration.

If candidate communication devices 100 are not found (block 215) or if threshold criteria are not satisfied (block 230), the initiating communication device 100 determines if it is enabled to search the long-range network (block 245). If it is not enabled to search the long-range network 10, the initiating communication device 100 returns to the idle mode (block 200). However, if the long-range network option is enabled, the long-range is searched for candidate communication devices (block 250). If no candidate communication devices 100 are found (block 255), control returns to block 200. However, if candidate communication devices 100 are found (block 250), the communication devices 100 in the connection request mode send discrimination information to connection server 34 according to any known means (block 260). In the case of a mobile telephone example the discrimination and connection information may be transmitted to the connection server 34 using a cellular data call. In the case of a PDA example the discrimination and connection information may be communicated to the connection server 34 using a wireless network to internet connection. In the case of a two-way mobile transceiver the discrimination and connection information may be communicated to the connection server 34 using packet radio transmissions. Correlator 32 then compares the discriminators to generate a correlation metric M for each pair of initiating/candidate communication devices 100 (block 265).

Processor 30 determines if the correlation metric M of any communication device pair meets or exceeds a correlation threshold (block 270). It will be appreciated that the correlation metric may be weighted, as discussed above, and compared to one or more thresholds T₁, T₂, T₃, etc. If the threshold criteria are not satisfied, the communication device 100 returns to the idle mode (block 200). If the identified communication device pair is unique and not linked to any other devices (block 275), connection server 34 automatically initiates a long-range wireless connection between the matched pair, as described above (block 285).

However, if multiple device pairs have weighted correlation metrics that exceed the threshold criteria (blocks 270, 275), additional discrimination information may be requested and/or the discrimination information is updated (block 280). In response, new correlation metrics M are generated for each initiating/candidate device pair (block 265). This process (blocks 265-280) is repeated until a unique matched pair of communication devices 100 is identified. Once identified, connection circuit 34 initiates the long-range wireless connection (block 285), as discussed above.

As described above, the present invention is implemented in a communication device 100 configured to detect a periodic signal, to correlate the characteristics with characteristics of other periodic signals, and to automatically connect to another communication device 100 when the correlation metric meets or exceeds a minimum threshold requirement. However, communication devices 100 that do not include detection circuitry 120, a correlator 112, and/or the connection circuitry 114 may also take advantage of the present invention. In this scenario, an initiating user 12, a target user 14, or both may, for example, dial a special automatic connection phone number to connect to connection server 34 and enter a connection request mode. Once connected to the connection server 34, the user(s) 12, 14 may manually input a periodic signal, such as by periodically pressing a designated key on communication device 100 or by periodically generating an external audible or visual signal that is detected by the microphone 146 or camera. Each communication device 100 provides the periodic signal to controller 20 via a long-range wireless interface. Upon receiving the periodic signal, discriminator circuit 22 detects one or more of the discriminators of the periodic signal and correlator 32 correlates the detected discriminators with discriminators from other communication devices 100 in the connection request mode to determine the correlation metric between each device pair. Alternatively, controller 20 may provide the discriminators to another communication device 100 so that the correlator 112 may correlate the discriminators and generate the correlation metric. In any event, if the resulting correlation metric meets or exceeds the corresponding threshold, controller 20 automatically initiates a long-range wireless connection between the identified pair of communication devices 100.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of automatically initiating a long-range wireless connection between two or more communication devices via a long-range wireless network, the method comprising:
placing a first communication device in a connection request mode;
searching for one or more candidate communication device in the connection request mode;
exchanging information between the first communication device and the one or more candidate communication device; and
automatically initiating the long-range wireless connection via the long-range wireless network between the first communication device and one of the candidate communication devices based on the exchanged information.

2. The method of claim 1 wherein exchanging information comprises:
detecting one or more first discriminators associated with the connection request mode of the first communication device;
obtaining one or more candidate discriminators associated with the connection request mode of at least one of the candidate communication devices; and
selecting one of the candidate communication devices as a second communication device based on the first and candidate discriminators.

3. The method of claim 2 wherein selecting one of the candidate communication devices based on the first and second discriminators comprises:
correlating the first discriminators with each of the candidate discriminators to generate a correlation metric for each candidate communication device; and
selecting the second communication device as the candidate communication device corresponding to the correlation metric that meets or exceeds a threshold.

4. The method of claim 2 wherein exchanging information further comprises exchanging identification information between the first communication device and the second communication device.

5. The method of claim 4 wherein exchanging identification information comprises exchanging at least one of phone number information, IP address information, mobile identification information, and configuration information between the first communication device and the second communication device.

6. The method of claim 4 wherein automatically initiating the long-range wireless connection via the long-range wireless network comprises automatically initiating the long-range wireless connection between the first and second communication devices via the long-range wireless network using the identification information.

7. The method of claim 2 wherein detecting one or more first discriminators comprises detecting a location of the first communication device, and wherein obtaining one or more candidate discriminators comprises obtaining a location of at least one of the candidate communication devices.

8. The method of claim 2 wherein detecting one or more first discriminators comprises detecting a first stop time corresponding to stopping a first signal used to enter the first communication device into the connection request mode and wherein obtaining one or more candidate discriminators comprises obtaining one or more candidate stop times corresponding to stopping one or more signals used to enter the one or more candidate communication devices into the connection request mode.

9. The method of claim 2 wherein detecting one or more first discriminators comprises detecting a first start time corresponding to the first communication device entering the connection request mode, and wherein obtaining one or more candidate discriminators comprises obtaining at least one candidate start time corresponding to at least one of the candidate communication devices entering the connection request mode.

10. The method of claim 9 further comprising estimating a start time corresponding to at least one of the candidate communication devices entering the connection request mode, wherein the correlating step includes correlating the estimated start time with the obtained candidate start time.

11. The method of claim 2 wherein detecting one or more first discriminators comprises detecting one or more characteristics of a first periodic signal manually generated using the first communication device that serves as an audible or visual indication for requesting a connection with a specific candidate communication device, and wherein obtaining one or more candidate discriminators comprises obtaining one or more characteristics of candidate periodic signals representative of the observed audible or visual request to initiate a connection with the first communication device.

12. The method of claim 2 wherein detecting one or more first discriminators comprises detecting one or more characteristics of a first periodic signal manually generated using the first communication device, and wherein obtaining one or more candidate discriminators comprises obtaining one or more characteristics of candidate periodic signals manually generated by at least one of the candidate communication devices.

13. The method of claim 12 wherein the characteristics of the first and candidate periodic signals comprise one or more of a frequency, amplitude, phase, and direction.

14. The method of claim 12 wherein each of the first and candidate periodic signals comprises at least one of a visual periodic signal and an audio periodic signal.

15. The method of claim 1 wherein placing the first communication device in the connection request mode comprises detecting a periodic signal manually generated using the first communication device.

16. The method of claim 1 wherein placing the first communication device in the connection request mode comprises detecting an activation of a control button on the first communication device.

17. The method of claim 1 wherein placing the first communication device in the connection request mode comprises contacting the controller via the long-range wireless network using at least one of a designated phone number, a designated IP address, and a designated packet radio address.

18. The method of claim 1 wherein automatically initiating the long-range wireless connection comprises:
obtaining long-range wireless identification information associated with a second communication device selected from the candidate communication devices based on the exchanged information; and
automatically initiating the long-range wireless connection between the first and second communication devices using the obtained long-range wireless identification information.

19. The method of claim 1 wherein searching for candidate communication devices comprises using a short-range wireless interface to search for the candidate communication devices operating in the connection request mode.

20. The method of claim 1 wherein searching for candidate communication devices comprises using a long-range wireless interface to search for the one or more candidate communication devices, and wherein exchanging information comprises exchanging information between the first communication device and the one or more candidate communication devices operating in the connection request mode via the long-range wireless interface.

21. The method of claim 1 wherein automatically initiating the long-range wireless connection comprises:
obtaining frequency configuration information associated with a second communication device selected from the one or more candidate communication devices based on the exchanged information; and
automatically configuring the first communication device using the obtained frequency configuration information associated with the second candidate communication device.

22. A first communication device that automatically initiates a long-range wireless connection with at least one other communication device in a long-range wireless network, the first communication device comprising:
an input device to place the first communication device in a connection request mode;
a short-range transceiver to search for one or more candidate communication devices operating in the connection request mode, and to exchange information between the first communication device and at least one of the candidate communication devices; and
connection circuitry to initiate the long-range wireless connection based on the exchanged information.

23. The first communication device of claim 22 further comprising detection circuitry to detect one or more first discriminators associated with the connection request mode of the first communication device.

24. The first communication device of claim 23 wherein the first discriminators comprise one or more characteristics of a periodic signal associated with the connection request mode of the first communication device.

25. The first communication device of claim 24 wherein the detection circuitry comprises at least one of a direction detector, a frequency detector, an amplitude detector, and a phase detector.

26. The first communication device of claim 23 wherein the detection circuitry comprises a location detector to determine a location of the first communication device.

27. The first communication device of claim 23 wherein the detection circuitry comprises a timer to determine a start time associated with a beginning of the connection request mode of the first communication device.

28. The first communication device of claim 23 wherein the exchanged information comprises one or more candidate discriminators associated with the connection request mode of the candidate communication devices.

29. The first communication device of claim 28 further comprising a selection circuit to generate a selection metric based on the first and candidate discriminators.

30. The first communication device of claim 29 wherein the selection circuit comprises a correlator, wherein the selection metric comprises a correlation metric generated by correlating the first and candidate discriminators.

31. The first communication device of claim 29 wherein the exchanged information comprises long-range wireless identification information associated with the one or more candidate second communication devices, wherein the second communication device corresponds to the candidate communication device having the selection metric that meets or exceeds a threshold, and wherein the connection circuitry automatically initiates the long-range wireless connection using the long-range wireless identification information associated with the second communication device.

32. The first communication device of claim 22 wherein the input device comprises a control button disposed on the first communication device.

33. The first communication device of claim 22 wherein the input device comprises a periodic signal detector that places the first communication device in the connection request mode responsive to detecting a periodic signal manually generated by the first communication device.

34. The first communication device of claim 33 wherein the periodic signal detector comprises a motion sensor for detecting periodic motion associated with the first communication device.

35. The first communication device of claim 34 wherein the motion detector comprises at least one of an accelerometer, an inertial switch, and a camera.

36. The first communication device of claim 33 wherein the periodic signal detector comprises audio circuitry to detect an audio periodic signal associated with the connection request mode of the first communication device.

37. The first communication device of claim 22 further comprising an accessory device operatively connected to the first communication device, wherein the input device is disposed in the accessory device.

38. The first communication device of claim 37 wherein the accessory device comprises a motion detector.

39. The first communication device of claim 22 further comprising a long-range transceiver for searching for one or more candidate communication devices operating in the connection request mode.

40. The first communication device of claim 39 wherein the long-range transceiver further exchanges information between the first communication device and at least one of the candidate communication devices.

41. A first wireless communication device that automatically initiates a long-range wireless connection with at least one other wireless communication device in a long-range wireless network, the first wireless communication device comprising:
an input device to receive an input signal to place the first wireless communication device in a connection request mode;
a long-range wireless transceiver to detect one or more candidate wireless communication devices operating in the connection request mode, and to receive information from at least one of the candidate wireless communication devices operating in the connection request mode; and
connection circuitry to initiate the long-range wireless connection based on the received information.

42. The first wireless communication device of claim 41 further comprising detection circuitry to detect one or more first discriminators associated with the connection request mode of the first wireless communication device.

43. The first wireless communication device of claim 42 wherein the information received by the transceiver comprises one or more candidate discriminators associated with the connection request mode of at least one of the candidate wireless communication devices.

44. The first wireless communication device of claim 43 further comprising a selector circuit to generate a selection metric for each of the candidate wireless communication devices based on the one or more first discriminators and the one or more candidate discriminators.

45. The first wireless communication device of claim 44 wherein the selector circuit comprises a correlator, and wherein the selection metric comprises a correlation metric generated for each of the candidate wireless communication devices by correlating the one or more candidate discriminators associated with each candidate wireless communication device with one or more first discriminators.

46. The first wireless communication device of claim 44 wherein the received information comprises identification information associated with at least one of the candidate wireless communication devices, wherein a second wireless communication device corresponds to the candidate wireless communication device having the selection metric that meets or exceeds a threshold, and wherein the connection circuitry initiates the long-range wireless connection using the received identification information associated with the second wireless communication device.

47. A method of automatically initiating a long-range wireless connection between two or more communication devices via a long-range wireless network, the method comprising:
detecting that a first communication device is operating in a connection request mode;
detecting that one or more candidate communication devices are operating in the connection request mode;
receiving information from the first communication device and at least one of the candidate communication devices; and
automatically initiating the long-range wireless connection between the first communication device and one of the candidate communication devices based on the received information.

48. The method of claim 47 wherein receiving information comprises:
receiving from at least one of the candidate communication devices one or more candidate discriminators associated with the connection request modes of the candidate communication devices; and
transmitting the candidate discriminators to the first communication device;
receiving from the first communication device an indication of which candidate communication device was selected by the first communication device as a second communication device based on the candidate discriminators.

49. The method of claim 48 wherein receiving information further comprises receiving long-range wireless identification information from at least one of the first communication device and the second communication device, and wherein automatically initiating the long-range wireless connection between the first communication device and one of the candidate communication devices comprises automatically initiating the long-range wireless connection between the first and second communication devices using the received long-range wireless identification information.

50. The method of claim 47 further comprising:
detecting one or more candidate discriminators associated with the connection request mode of at least one of the candidate communication devices;
transmitting the candidate discriminators to the first communication device; and
receiving from the first communication device an indication of which candidate communication devices was selected by the first communication device as a second communication device based on the candidate discriminators.

51. The method of claim 50 wherein receiving information further comprises receiving long-range wireless identification information from at least one of the first communication device and the second communication device, and wherein automatically initiating the long-range wireless connection between the first communication device and one of the candidate communication devices comprises automatically initiating the long-range wireless connection between the first and second communication devices using the received long-range wireless identification information.

52. The method of claim 47 further comprising:
receiving from the first communication device one or more first discriminators associated with the connection request mode of the first communication device;
receiving from at least one of the candidate communication devices one or more candidate discriminators associated with the connection request modes of the candidate communication devices;
generating a correlation metric for each candidate communication device, the correlation metric representing a correlation between the first and candidate discriminators; and
selecting the candidate communication device having a correlation metric that meets or exceeds a threshold as a second communication device.

53. The method of claim 52 wherein receiving information further comprises receiving long-range wireless identification information from at least one of the first communication device and the second communication device, and wherein automatically initiating the long-range wireless connection between the first communication device and one of the candidate communication devices comprises automatically initiating the long-range wireless connection between the first and second communication devices using the received long-range wireless identification information.

54. The method of claim 47 further comprising:
receiving from the first communication device one or more first discriminators associated with the connection request mode of the first communication device;
detecting one or more candidate discriminators associated with the connection request mode of at least one of the candidate communication devices;
generating a correlation metric for each candidate communication device, the correlation metrics representing a correlation between the first and candidate discriminators; and
selecting the candidate communication device having a correlation metric that meets or exceeds a threshold as a second communication device.

55. The method of claim 54 wherein receiving information further comprises receiving long-range wireless identification information from at least one of the first communication device and the second communication device, and wherein automatically initiating the long-range wireless connection between the first communication device and one of the candidate communication devices comprises automatically initiating the long-range wireless connection between the first and second communication devices using the received long-range wireless identification information.

56. The method of claim 47 further comprising:
detecting one or more first discriminators associated with the connection request mode of the first communication device;
detecting one or more candidate discriminators associated with the connection request mode of at least one of the candidate communication devices;
generating a correlation metric for each candidate communication device, the correlation metrics representing a correlation between the first and candidate discriminators; and
selecting the candidate communication device having a correlation metric that meets or exceeds a threshold as a second communication device.

57. The method of claim 56 wherein receiving information further comprises receiving long-range wireless identification information from at least one of the first communication device and the second communication device, and wherein automatically initiating the long-range wireless connection between the first communication device and one of the candidate communication devices comprises automatically initiating the long-range wireless connection between the first and second communication devices using the received long-range wireless identification information.

58. A wireless network for initiating a long-range wireless connection between two or more communication devices comprising:
a long-range wireless interface to detect a first communication device and one or more candidate communication devices operating in a connection request mode, and to receive information from the first communication device and at least one of the candidate communication devices; and
a connection server to automatically initiating the long-range wireless connection between the first and second communication devices based on the received information.

59. The wireless network of claim 58 further comprising a correlator to generate a correlation metric for each candidate communication device by correlating one or more discriminators associated with the connection request mode of the first communication device with each of one or more discriminators associated with the connection request mode of the candidate communication devices.

60. The wireless network of claim 58 further comprising detection circuitry to detect one or more discriminators associated with the connection request mode of at least one of the first and candidate communication devices.

61. The wireless network of claim 60 wherein the detection circuitry includes at least one of a direction detector, a frequency detector, an amplitude detector, and a phase detector to detect at least one of a direction, a frequency, an amplitude, and a phase associated with the connection request mode of at least one of the first and candidate communication devices.

62. The wireless network of claim 60 wherein the detection circuitry includes at least one of a direction detector, a frequency detector, an amplitude detector, and a phase detector to detect at least one of a direction, a frequency, an amplitude, and a phase of an audible or visual signal relative to a real-time timer used respectively by the first and candidate communication devices to mutually request initiating a long-range wireless connection between the first communication device and at least one of the candidate communication devices.

63. The wireless network of claim 58 wherein the connection server receives discrimination information from the first communication device operating in the connection request mode and at least one of the candidate communication devices operating in the connection request mode.

64. The wireless network of claim 58 wherein the connection server receives identification information from the first communication device operating in the connection request mode and at least one of the candidate communication devices operating in the connection request mode.

65. A method of automatically initiating a long-range wireless connection between two or more communication devices via a long-range wireless network, the method comprising:
placing a first communication device in a connection request mode;
searching for candidate communication devices in the connection request mode;
receiving discriminators from the candidate communication devices;
selecting a second communication device from the candidate communication devices based on the discriminators;
exchanging identification information between the first and second communication devices; and
automatically initiating the long-range wireless connection using the exchanged identification information.
